(19) United States
(12) Patent Application Publication
(10) Pub. No.: US 2006/0224394 A1
(43) Pub. Date: Oct. 5, 2006

(54) Timeslot sharing over different cycles in tdma bus

(75) Inventors: Jorn Ungermann, Aachen (DE); Peter Fuhrmann, Aachen (DE); Manfred Zinke, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,259

(22) PCT Filed: Apr. 26, 2004
(86) PCT No.: PCT/IB04/50512

§ 371 Date: Nov. 1, 2005

(30) Foreign Application Priority Data
May 6, 2003 (EP) 031 01 254.5

(51) Int. Cl. G06Q 99/00; G05B 19/418; G06F 9/46

(52) U.S. Cl. 705/1; 705/8

(57) ABSTRACT

The invention relates to a method of transmitting user data via a communications medium (2) between subscribers (3) connected to the communications medium (2), wherein the data are transmitted in recurrent cycles (8) and at least one slot (9, 10) in each cycle (8) is intended for the user data of at least one subscriber (3). In order to permit a particularly efficient data transmission via the communications medium (2) at least one of the slots (10) is used to transmit the user data of different subscribers (3) (A, C, F) in different cycles (8). In addition, a bus guardian (6) of one subscriber (3) determines whether the subscriber (3) may transmit user data in the current slot (9, 10) of the current cycle (8), the bus guardian (6) having at least indirect access to a universal condition available throughout the entire communications system (1). In particular, an internal counter of the bus guardian (6) is synchronized to a universal cycle counter.

The present invention relates to a method of transmitting user data via a communications medium between subscribers connected to the communications medium. The data are transmitted in recurrent cycles. In each cycle at least one slot is intended for the user data of at least one subscriber.

The invention further relates to a computer program which is capable of running on a computing element, particularly on a microprocessor.

The present invention furthermore relates to a subscriber which is connected to a communications medium and transmits user data via the communications medium to other subscribers connected to the communications medium. The data are transmitted in recurrent cycles. In each cycle at least one slot is intended for the user data of at least one subscriber.

In addition the invention relates to a bus guardian, which is assigned to a subscriber connected to a communications medium. The subscriber transmits user data via the communications medium to other subscribers connected to the communications medium. The data are transmitted in recurrent cycles. In each cycle at least one slot is intended for the user data of at least one subscriber.

The invention finally also relates to a communications system comprising a communications medium and a plurality of subscribers connected thereto. User data are transmitted between the subscribers in recurrent cycles via the communications medium. In each cycle at least one slot is intended for the user data of at least one subscriber.

For the next generation of time-controlled communications systems it is proposed to use a so-called bus guardian. Each bus guardian is assigned to a specific subscriber on the communications system. The bus guardian has information on when the subscriber assigned to it may transmit data and when it may not. The bus guardians serve to prevent defective subscribers on the communications system continuously transmitting data and blocking the communications medium. Such defective subscribers are also referred to as babbling idiots. The bus guardian derives a control signal from an independent set of configuration data and by means of the control signal allows the subscriber access to the communications medium only for selected time slots, for which the subscriber's communications controller (CC) may transmit data. This prevents a defective communications controller and/or a defective subscriber monopolizing the communications medium.

A TDMA (time division multiple access) system is generally used as access system to the communications medium. In this system a predefined period of a so-called cycle is divided into multiple time slots, each of the time slots being of a specific (generally constant) length. In each slot only one communications controller of a specific subscriber may transmit data.

Whilst the bus guardian can be configured by means of information relating to the slot, in which the communications controller assigned to the bus guardian may transmit data, the bus guardian lacks the ability to determine the start of a cycle from the data received or from the communication via the communications medium. In order to be able to derive this autonomously, the bus guardian would have to comprehend and interpret the communication via the communications medium, which would, however, make the bus guardian extremely complex, prone to error and expensive. For this reason the communications controller has to send a trigger signal (the so-called ARM signal) to the bus guardian, in order to indicate the start of the first cycle in which the communications controller intends to transmit slots. The bus guardian can then autonomously infer the start of the ensuing cycles from their configuration and can compare this knowledge with the continuously incoming ARM signal from the communications controller. The ARM signal indicates when the internal sequence of the cycle inside the communications controller begins. Should the bus guardian detect a discrepancy between its own view of the start of the cycle and that of the communications controller, it deactivates the transmission capability of the subscriber, a defective subscriber or communications controller thereby being compelled to remain silent (so-called fail-silent behavior), which is advantageous in restricting errors in the communications system.

In an error-tolerant communications system a TDMA system is used in order to ensure a uniform and reliable data transmission. Since highly precise timer synchronization algorithms presuppose short resynchronization cycles, only a limited number of slots will fit into in one communications cycle.

It is an object of the invention, therefore, to provide a particularly efficient data transmission via the communications medium.

Proceeding from the aforementioned method of transmitting user data, the present invention proposes to achieve this object by using at least one of the slots to transmit the user data of different subscribers in different cycles.

According to the invention, therefore, proposed to assign at least one so-called shared slot of the cycle is assigned not just to one single subscriber but to multiple subscribers as a function of the current cycle. This means, for example, that in a first cycle a first subscriber on the communications system can transmit user data via the communications medium, in a second cycle a second subscriber can transmit user data via the communications medium and in a third cycle a third subscriber can transmit data via the communications medium using one and the same slot. Although this reduces the attainable band width for the data transmission of a subscriber, in many applications such a reduced band width will be sufficient for. The net result therefore is that more subscribers can then be connected to a communications medium without having to increase the cycle times.

For the purposes of the present invention user data basically comprise any type of data and information. In particular, the communications system also comprises messages and signaling data using information to control the communication sequence.

According to one advantageous further embodiment of the present invention one of the subscribers decides, on the basis of a condition available universally to all subscribers, whether in the current cycle it may transmit user data in at least one shared slot. According to this further embodiment there is therefore no higher-ranking unit in the communications system granting transmission entitlement to the individual subscribers. Instead, each subscriber on the communications system decides for itself whether in the current cycle it may transmit user data via the shared slot. This decision is made by all subscribers on the communications system on the basis of the same universally available condition.

According to a preferred embodiment of the present invention a cycle counter is used as universally available condition, by means of which a code is assigned to each of the successive cycles within a metacycle, one metacycle comprising a plurality of cycles. The cycle counter assigns to each cycle a largely unambiguous code within the metacycle. Between two cycles the cycle counter adjusts its value in the same way and at the same time in a manner detectable by all subscribers (within the accuracy of the communications system). Normally the cycle counter behaves cyclically, so that the value of the cycle counter periodically repeats itself after a specific number of cycles. The longest period of time over which the cycle counter does not repeat itself, is referred to as the so-called metacycle. The cycle counter enables different communications controllers or subscribers to share a slot, on condition that for each cycle counter value only one subscriber has permission to transmit data via the shared slot.

The cycle counter consequently defines so-called subslots for those slots which can be used to transmit the user data of different subscribers in different cycles. Whilst according to the invention these slots can therefore be used by multiple subscribers, only one subscriber is assigned to each subslot. At least one subslot of the shared slot is assigned to each subscriber which in at least one cycle is allowed to use, the common slot in order to transmit data. A subslot is provided for each value of the cycle counter. The subslots are distributed between the subscribers on the communications system. A communications system may also contain multiple shared slots useable by different subscribers.

A communications controller can access multiple subslots, in one or more different shared slots.

Since a bus guardian per se does not have any information on the current value of the cycle counter, it cannot monitor the shared slots. For slots in which, depending on the current cycle, different subscribers can transmit user data, the bus guardian must therefore always allow the subscriber assigned to it to transmit data. This means that whereas in slots useable by only one subscriber, only this one subscriber receives permission from its assigned bus guardian to transmit data, in the case of shared slots theoretically all the subscribers on the communications system which share the use of this slot can transmit data. If one of the subscribers is defective, therefore, and constantly transmits data via the communications system, this defective subscriber could block the entire communications medium, at least in the slots shared (so-called babbling idiot). In the case of shared slots, therefore, the bus guardian cannot fulfill the function for which it was actually intended.

In order to remedy this, according to another advantageous further embodiment of the present invention a bus guardian assigned to one of the subscribers determines whether the subscriber may transmit user data in the current slot of the current cycle, the bus guardian having at least indirect access to the universally available condition, in particular the cycle counter. There are various possible ways of synchronizing the bus guardian to the universally available cycle counter.

In a first step the cycle counter in the communications controller must be monitored. For this purpose the cycle counter between the communications controller and the bus guardian must be synchronized. Following an initial synchronization the bus guardian can monitor the cyclical behavior of the cycle counter of the communications controller. Both the initial synchronization and the subsequent monitoring may be performed directly or indirectly.

In a second step the bus guardian must monitor the access pattern of the communications controller to the communications medium. Various levels of protection are possible here, and these will be described in detail below. Unless otherwise specified, it is hereinafter assumed that the bus guardian has information on which subslots in which shared slots are allocated to the subscriber assigned to the bus guardian.

According to a further preferred embodiment of the invention the bus guardian has a counter, which is synchronized with the cycle counter. The bus guardian counter constitutes an internal structure of the bus guardian which can be achieved with little additional cost. The synchronization of this counter to the universally available cycle counter may be performed directly or indirectly.

A direct synchronization can be advantageously performed by using a synchronization signal to synchronize the bus guardian counter with the cycle counter. A signal already present in the bus guardian may be used as synchronization signal. An example of such a signal is the ARM signal of the communications controller. In addition to the usual synchronization mechanism of the ARM signal, a synchronization signal is defined which ensures that the bus guardian and the communications controller have the same view of the cycle counter. By enabling the bus guardian to detect the current value of the cycle counter, the bus guardian can also monitor the shared slot in different cycles. The bus guardian allows the subscriber assigned to it access to the communications medium on a shared slot only for specific, predetermined values of the cycle counter.

At a preset time, the so-called synchronization time, the signal already present in the bus guardian advantageously assumes a predefinable value and the bus guardian counter is synchronized to the cycle counter when the signal assumes the predefinable value. It is feasible to use the unmodified ARM signal for the purpose of synchronization: the initial synchronization is performed when the cycle counter assumes a predefinable value. At this synchronization time an ARM trigger permits synchronization of the bus guardian to the transmission system and the cycle counter. Since a large number of different cycle counter values can occur with the need, in the worst case, to evaluate a complete metacycle, until the signal assumes the predefinable value, this relatively simple embodiment can lead to a long initial delay before the initial synchronization can be performed. For this reason, this embodiment is only suitable for less safety-relevant applications, since safety relevant applications generally need to be capable of rapid start-up, for example following a reset triggered by a fault.

The bus guardian counter is advantageously synchronized to the cycle counter the first time that the signal already present in the bus guardian assumes the predefinable value.

Another possible method of directly synchronizing the bus guardian to the condition universally available in the communications medium is to use a separate signal, not originally present in the bus guardian, as synchronization signal. The separate signal not originally present in the bus guardian may be a signal which as such already exists but which assumes entirely new signal values and signal patterns. In particular, the bus guardian counter is synchronized to the cycle counter when a signal already present in the bus guardian corresponds to a specific signal pattern. This embodiment can be achieved by using a signal which as such already exists but which assumes exceptional signal values or signal patterns hitherto unencountered. Examples of such exceptional signal values or signal patterns include a prolonged signal pulse, a multiple signal pulse, in particular a double pulse, or any other type of signal pattern.

However, the separate signal not originally present in the bus guardian may also be an entirely new signal, which is applied to the bus guardian via an additional or hitherto unused pin of the bus guardian. This serves to prevent misunderstandings or misinterpretations of a signal already present in the bus guardian, such as the ARM signal.

The synchronization signal synchronizes the bus guardian to the universally available condition, so that at the occurrence of the synchronization signal the bus guardian can also monitor the transmission mode of the communications controller, assigned to it, in the shared slot. Following synchronization, the bus guardian will permit a transmission mode of the assigned subscriber via the shared slots only for predefinable values of the cycle counter. The bus guardian can also monitor the cycle counter, since the communications controller must give the separate signal not originally present (e.g. the special ARM signal) each time that the cycle counter assumes the preset value. If a separate signal not originally present (e.g. the special ARM signal) is anticipated but is not forthcoming, although the internal counter points to a corresponding cycle counter value, a failure of the communications controller can be inferred. In this way the bus guardian and the communications controller cannot lose the synchronization without the bus guardian detecting this. Should the synchronization be lost, the bus guardian will permit no further data transmission of the communications controller and will set this to the so-called fail-silent state. In this way it is possible to prevent the dangerous effects which a defective subscriber may have on the entire communications system.

For indirect synchronization of the bus guardian to the universally available condition the bus guardian counter is synchronized in that the bus guardian observes the transmission mode of the subscriber assigned to it and synchronizes the counter accordingly. According to this embodiment, the bus guardian learns the sequence of accesses by the subscriber to the means of communications, in particular from the accesses observed at the start of data communications. From the outset, the bus guardian opens the shared slot, useable by multiple subscribers in different cycles. The communications controller waits for the smallest value of the cycle counter, for which it may access a subslot of a shared slot. The communications controller performs its first data transmission during this subslot.

The initial access to the communications medium by the communications controller via the shared slot is detected by the bus guardian and linked with the smallest value of the cycle counter at which the communications controller may transmit data. Now both the bus guardian and the communications controller have the same view of the cycle counter. Henceforth the bus guardian will permit data transmission by the communications controller via the communications medium only in the predetermined subslots of the shared slots, that is to say in the predetermined cycles. Should the subscriber use multiple shared slots, the initial data transmission triggers the synchronization in any one of these shared slots.

The bus guardian is capable of detecting an inadmissible access to the communications medium by the subscriber in the shared slots. Should the communications controller of the subscriber need to transmit data in the subslots assigned to it, the bus guardian can also monitor the cycle counter of the communications controller. Otherwise a quiescent communications controller (one not transmitting any data) might drift out of synchronization without the bus guardian detecting this.

Should no local information be available on the access sequence to the communications medium by the subscribers, the bus guardian uses the initial access to the communications medium by the communications controller during a shared slot in order to initialize its local counter with a predefinable value. This value need not necessarily be equal to the value of the cycle counter in the communications controller; but both the bus guardian counter and the cycle counter of the communications controller behave in the same cyclical way.

According to another advantageous further embodiment of the present invention, information on which slot and which cycle the subscriber assigned to the bus guardian may use to transmit user data is filed in the bus guardian as a preliminary to the data transmission. In this case therefore the bus guardian is preconfigured with the values of the cycle counter for each shared slot in which the subscriber assigned to the bus guardian or its communications controller may transmit data via the communications medium. This information can also be transmitted to the bus guardian by the host controller of the subscriber, once the communications system or the subscriber has been started up. This is advantageous, in particular, when the access sequence to the shared slot is dynamically allocated by a higher-level protocol, since this allocation is possible only after starting up the communications system.

According to a further preferred embodiment of the invention the bus guardian obtains information on which slot and which cycle the subscriber may use to transmit user data by observing the transmission mode of the subscriber assigned to it, and the information is filed in the bus guardian. In particular, information is obtained by the bus guardian under certain boundary conditions. Examples of these boundary conditions include the maximum number of admissible accesses to the shared slot by a subscriber during one metacycle. If the communications controller of the subscriber is defective from the outset therefore, and is constantly seeking to access the communications medium via the shared slot, such a fault will be detected by the bus guardian as soon as the communications controller seeks to access the communications medium via the shared slot more frequently than is admissible within a cycle,. In this way it is possible to ensure a certain minimum bandwidth in the communications system from the outset.

For safety reasons it may be a problem to amend the information for configuring the bus guardian during the running time. In this case the degree of monitoring security may be reduced, the information used to configure the bus guardian consisting solely of the number of subslots for the communications controller assigned to the bus guardian for each shared slot. When the subscriber assigned to the bus guardian has therefore already accessed the communications medium a number of times equal to the number of subslots filed in the bus guardian, the bus guardian prevents any further access by the subscriber in this cycle.

Depending on the permissible complexity or the need for safeguards, two further possibilities are feasible which do not require any configuration of the bus guardian by the host controller of the subscriber using all the sequence information on access to the communications medium by the communications controller:

One possibility relates to safeguarding of the bandwidth. Firstly the bus guardian can detect the number of subslots in which the assigned communications controller may transmit data in the existing shared slots.

For a direct synchronization, the bus guardian first blocks the access to the communications medium by the communications controller in all shared slots. From the first synchronization event, the bus guardian allows the communications controller access to the shared slots for all shared slots. For an indirect synchronization access to the communications medium is permitted from the outset.

The bus guardian has a counter of its own for each shared slot. Each access to the communications medium by the communications controller in this shared slot increases the counter. As soon as the counter reaches a predefinable maximum value the bus guardian blocks the access to the communications medium via the shared slots from the succeeding cycle onwards. The predefinable maximum value is equal to the number of assigned subslots for this shared slot.

The local bus guardian counter is reset either by the cycle counter synchronization signal or when, according to the internal understanding of the bus guardian, the cycle counter has completed a full cycle running through all possible values.

In this way it is possible to prevent the communications controller occupying more than the bandwidth of a specific shared slot assigned to it. However, this does not serve to prevent the communications controller transmitting data during subslots in which the communications controller really should not transmit. Nevertheless, the volume of communications on the communications medium that may be adversely affected by a defective communications controller can be markedly reduced compared to one without monitoring. Furthermore, this option is relatively easy to implement and is well-suited to dynamic slot allocation, since no configuration data are required in the bus guardian that are not already available before starting up the communications system.

A further possibility which does not require any configuration of the bus guardian by the host controller using all the sequence information on access to the communications medium is the self-configuring bus guardian.

The bus guardian detects the number of subslots in which the communications controller assigned to it may transmit data for each of the existing shared slots.

For a direct synchronization the bus guardian first blocks access to the communications medium by the communications controller in all shared slots. From the first synchronization onwards, the bus guardian allows the communications controller access to the communications medium in all shared slots. For indirect synchronization access to the communications medium is possible from the outset.

During the first metacycle the bus guardian observes very closely the access behavior of the communications controller assigned to it. The bus guardian stores the access pattern of the communications controller in its internal configuration register. The first metacycle is started either by the first direct synchronization event or, in the case of indirect synchronization, by the first transmission event of the communications controller in a subslot of a shared slot. The first metacycle is terminated when the cycle counter has run through all values which it can theoretically assume.

After the first metacycle, the bus guardian blocks access to the communications medium during all shared slots with the exception of those subslots of the shared slots in which the communications controller has transmitted data during the first metacycle.

Even during the first metacycle, the bus guardian can afford the same protection as in the first possible method described above, in which access to the communications medium is limited to specific subslots. An initially fault-free communications controller cannot corrupt the communication in the shared slot, since the configuration of the bus guardian cannot be modified. A defective communications controller cannot disrupt just any slot, but only the same slot in each cycle. An intelligent applications level could detect such behavior and divert the corrupted information.

The present invention can be implemented in hardware. However, the implementation of the method according to the invention in the form of a computer program is of particular significance.. In this case the computer program is capable of running on a computing element, in particular on a microprocessor, and is programmed to perform the method according to the invention. Here, therefore, the invention is implemented by the computer program, so that this computer program represents the invention in the same way as the method it is programmed to execute. The computer program is preferably stored on a memory storage element. In particular, an electrical storage medium, such as a random access memory, a read-only memory or a flash memory may be used as storage medium.

Proceeding from a subscriber of the aforementioned type, the object of the present invention is further achieved in that at least one of the slots in different cycles is intended for the transmission of user data of different subscribers, and the subscriber in a predefinable cycle transmits user data in the shared slot.

Proceeding from a bus guardian of the aforementioned type, the object of the present invention is further achieved in that at least one slot is provided via which user data of different subscribers can be transmitted in different cycles, the bus guardian checking whether the subscriber may transmit user data in the current slot of the current cycle.

Finally, proceeding from a communications system of the aforementioned type the object of the present invention is further achieved in that at least one of the slots is intended for the transmission of the user data of different subscribers in different cycles.

### The invention will be further described with reference to examples of embodiments shown in the drawings to which, however, the invention is not restricted, and in which:

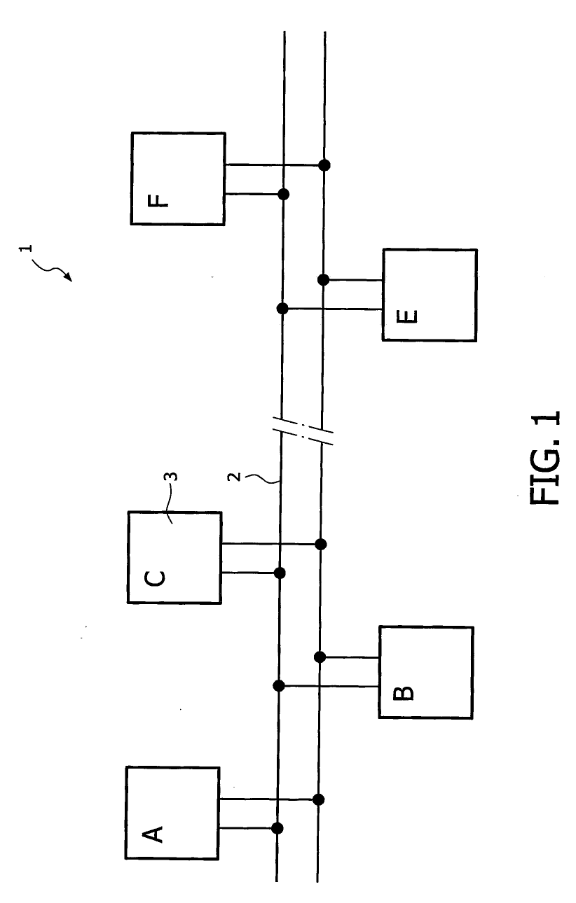

FIG. 1 shows a preferred embodiment of a communications system according to the invention;

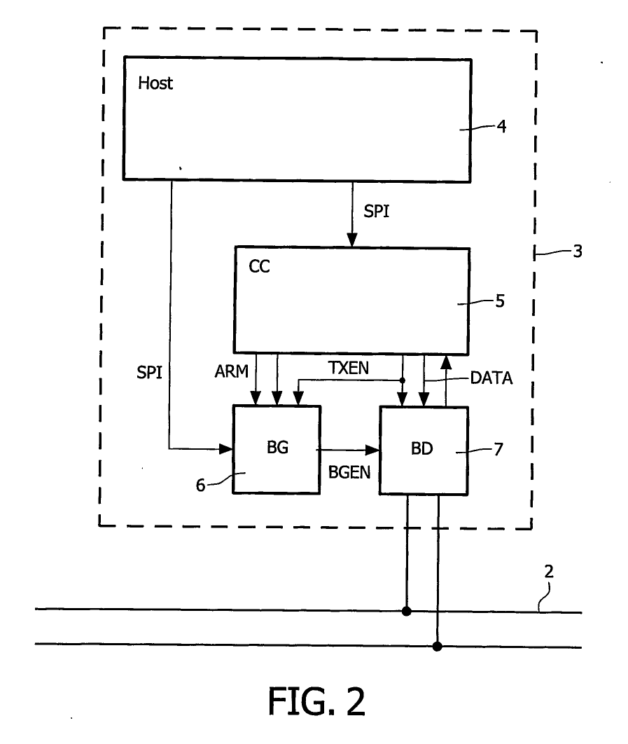

FIG. 2 shows a preferred embodiment of a subscriber according to the invention for the communications system in FIG. 1;

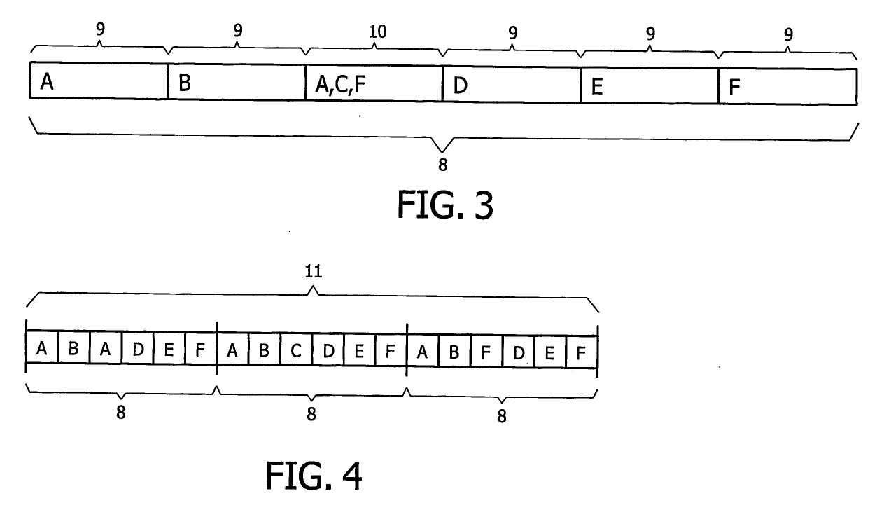

FIG. 3 shows a cycle having multiple slots which are used for data transmission via a communications medium of the communications system according to FIG. 1;

FIG. 4 shows a metacycle having multiple cycles according to FIG. 3; and

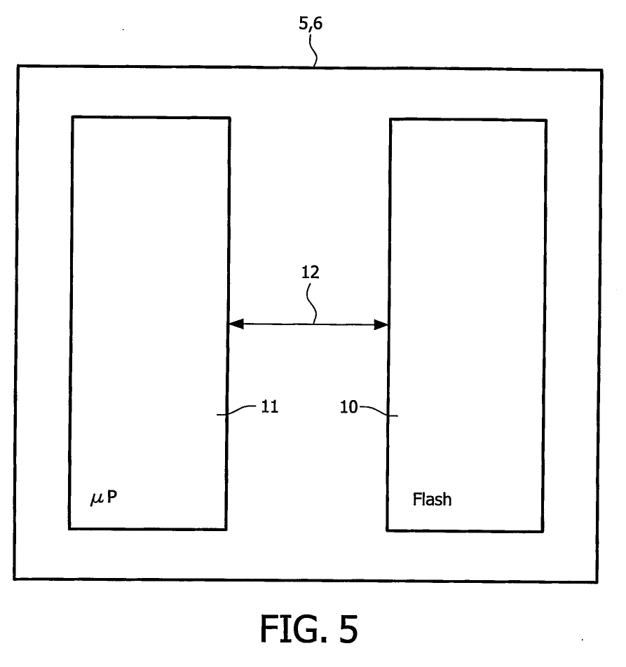

FIG. 5 shows a preferred embodiment of a communications controller and a bus guardian of a subscriber according to the invention as in FIG. 2.

In FIG. 1 a communications system according to the invention is denoted in its entirety by the reference numeral 1. The communications system 1 comprises a communications medium 2, which takes the form of a data bus. The communications system takes the form, for example of a data bus. In addition to the bus structure of the communications medium 2 shown in FIG. 1 this can also have a star structure or a any other structure. Connected to the communications medium 2 are subscribers 3 (which are also referred to as nodes), which are denoted by A, B, C, . . . E. The communications system 1 is, for example, a FlexRay communications system.

FIG. 2 shows the construction of the subscribers 3 in detail. Each subscriber 3 comprises a host controller 4, a communications controller 5, a bus guardian 6 and a bus driver 7. The host 4 configures both the communications controller 5 and the bus guardian 6 with all relevant configuration data. In particular, both are configured with sequence information. The sequence information contains details of which subscriber 3 may transmit data when, via the communications medium 2.

The logic components represented in the figures can naturally be freely combined with one another. Thus a combined bus driver (BD)/bus guardian (BG) device, for example, is feasible.

In a FlexRay communications system 1 data are transmitted in recurrent cycles (cf. FIG. 3). Each cycle 8 comprises six slots 9, 10 for the user data of the subscribers 3. Whilst the first, second, fourth, fifth and sixth slots 9 are assigned to a single subscriber 3, the third slot 10 is intended for the transmission of user data of different subscribers 3 (A, C, F) in different cycles 8.

FIG. 4 shows a so-called metacycle 11 for data transmission, which in this example comprises three cycles 8. It can clearly be seen that the subscriber A transmits user data in the third slot 10 during the first cycle 8. During the second cycle 8 the subscriber C transmits user data in the third slot 10, and during the third cycle 8 the subscriber F transmits user data in the third slot 10.

The sequence information with which the communications controller 5 and the bus guardian 6 are configured, comprises the length of a communications cycle 8, the length of a static segment (for example a TDMA (time divisional multiple access)-based segment), the length of a dynamic segment (a segment, in which the transmission of a slot within a limited time cannot be guaranteed) and various other protocol-specific segments.

Each subscriber 3 may have no slot, or one or more slots in the static segment, within which the subscriber 3 may transmit data. The host 4 detects this information and configures the communications controller 5 and the bus guardian 6 according to this information.

In addition to this already defined flowchart some slots in the static segment are configured as slots 10 configures, via which user data of different subscribers 3 can be transmitted in different cycles (so-called shared slot). In the example of an embodiment in FIG. 3 the slot 10 would be such a slot useable by multiple subscribers A, C, F. Subscribers 3 not seeking to transmit any data in such a shared slot 10 useable by multiple subscribers 3 need not necessarily know that these shared slots 10 useable by multiple subscribers 3 have a special status. The subject matter of the present invention is downwardly compatible with FlexRay communications systems, which do not support any shared slots 10 useable by multiple subscribers 3.

In FlexRay communications systems a so-called cycle counter is provided, which assigns a code to the different successive cycles 8. The cycle counter represents a condition universally available throughout the communications system 1, on the basis of which it is possible to decide whether or not a subscriber 3 in the current cycle 8 may transmit user data in the shared slot 10 useable by multiple subscribers 3. The cycle counter can assume values between 0 and 63. Thus up to 64 different subscribers 3 can use a shared slot 10 useable by multiple subscribers 3. Should more subscribers 3 wish to use the shared slot 10 useable by multiple subscribers 3, the admissible range of the cycle counter would have to be increased. The shared slot 10 useable by multiple subscribers 3 can be used for the exchange of network, control or status information. In this case a specific value of the cycle counter would be assigned to each subscriber 3. In this way it is possible to ensure that each subscriber 3 can signal its status within a specific period of time, only a small part of the bandwidth being needed for signaling. The method according to the invention affords advantages particularly where in specific applications it is unacceptable for each subscriber 3 to be assigned its own static slot 9, since this leads to a large length of the cycle 8.

Each host 4 of a subscriber 3 is preconfigured with information on the cycle 8 in which the communications controller 5 may transmit slots within a shared slot 10 useable by multiple subscribers 3. During the configuration phase the host 4 relays the configuration data to the communications controller 5 and to the bus guardian 6, the configuration phase preceding the start-up of the communications system 1.

The communications controllers of a FlexRay communications system start up in a manner known in the art. They establish a universal time base and initialize their sequences. As soon as a communications controller 5 is synchronized with another subscriber 3, it signals the start of the first cycle 8, in which the communications controller 5 seeks to transmit slots, to the bus guardian 6 by means of a so-called ARM signal. The shared slot 10 useable by multiple subscribers 3 cannot yet be used, since the bus guardian 6 does not know which cycle 8 the communications system 1 is in. For this reason the bus guardian 6 initially refuses the communications controller 5 access to the communications medium 2 via a shared slot 10.

That subscriber 3 which initiates a cold start initializes its cycle counter to 0, but all subscribers 3 which then start up (so-called integrating subscribers or integrating nodes) can be incorporated into the communications system 1 at the start of each freely selectable cycle (the so-called arbitrary cycle). As soon as the cycle counter has reached its maximum value and is reset to 0, the communications controller 5 sends a special ARM signal to the bus guardian 6, in this example a extended signal pulse. Henceforth the bus guardian 6 determines whether the extended ARM signal is present after each 64 cycles 8. The bus guardian 6 also permits data transmission in the shared slot 10 useable by multiple subscribers 3 for those cycles 8 which have been configured by the host 4.

A further example of an embodiment of the present invention will be described below. It is based on a FlexRay communications system 1, as is shown in FIG. 1. In addition to the flowchart already defined, in this example of an embodiment the subslots of the shared slot 10 useable by multiple subscribers 3 are dynamically assigned to the subscribers 3 after starting-up. On one application level each subscriber 3 is assigned the required number of subslots for each shared slot 10 useable by multiple subscribers 3. In this case the number of subslots for each shared slot 10 useable by multiple subscribers 3 was known beforehand and was also known to the host controller 4, which has relayed this information to the bus guardian 6.

The communications system 1 starts up quite normally. After starting up the hosts 4 can exchange information and the mechanism of the application level can distribute the information on which subscriber 3 may transmit during which subslot of which shared slot 10 useable by multiple subscribers 3.

The bus guardian 6 monitors the TXEN (transmission enable) signal of the communications controller 5, by means of which the communications controller 5 of the bus driver 7 requests access to the communications medium 2. For each shared slot 10 useable by multiple subscribers 3 in the flowchart, the bus guardian 6 has a special counter, with which it counts the number of subslots during which the communications controller 5 assigned to the bus guardian 6 has accessed the communications medium 2. When the predefined maximum value is reached, the bus guardian 6 prevents further access until the cycle counter attains the preconfigured value, which in the case of a FlexRay communications system 1 is zero. The counters are then reset and access to the communications medium 2 during the shared slot 10 useable by multiple subscribers 3 is again permitted until the counters reach their maximum value again.

The present invention therefore does not, as hitherto, merely assign at least one of the slots to a single subscriber 3 but creates a facility allowing different subscribers 3 (A, C, F) to transmit data via this slot 10 in different cycles 8. In addition it affords the facility for using a special bus guardian 6 to monitor subscribers 3 (A, C, F), which access such a shared slot 10 useable by multiple subscribers 3 and transmit data via this, in order, for example, to prevent a single defective subscriber 3 exclusively occupying the entire bandwidth of the communications medium 2 (so-called babbling idiot). This can be achieved in that the bus guardian 6 of the subscriber 3 has access to a universally available condition, in this example to the cycle counter, which serves to define which of the subscribers 3 in the current cycle 8 may transmit data in the shared slot 10 useable by multiple subscribers 3. A local counter of the bus guardian 6 is synchronized with the cycle counter, so that an entitlement of the subscriber 3 to transmit data in the current cycle 8 data can be monitored on the basis of the local counter.

Various possibilities are proposed for synchronizing the local counter of the bus guardian 6 with the universally available cycle counter. One feasible option is direct synchronization, in which the counter is actively synchronized by means of a synchronization signal. Another possibility is indirect synchronization, in which the bus guardian 6 first observes the transmission mode of the subscriber assigned to it, the counter being synchronized accordingly.

A signal that is already present in the subscriber 3 and is applied to the bus guardian 6, such as the ARM signal, may be used as synchronization signal. Synchronization can occur when this signal first assumes a predefinable value after starting up the communications system 1. Synchronization can equally well occur when this signal has a predefinable signal pattern. Alternatively, an independent signaling signal may be provided, which is applied to a separate or hitherto unused pin on the bus guardian 6.

For performing the method according to the invention, information relating to the cycle 8 in which the subscriber 3 may transmit data via the communications medium 2 is filed at least in the communications controller 5 of a subscriber 3. Data to be transmitted are transmitted only when the universal cycle counter has assumed a value corresponding to the cycle for which the subscriber 3 has a transmission entitlement in the shared slot 10 useable by multiple subscribers 3. For this purpose the communications controller 5 must check the current value of the cycle counter and compare it with the configuration data. If the comparison a results in a match, the communications controller 5 sends a data transmission instruction to the bus driver 7.

If the communications controller 5 is protected by a bus guardian 6, this bus guardian 6 must be synchronized with the cycle counter and must enter the current value of the cycle counter, compare it with configuration data and in the event of a match must grant the bus driver 7 permission to transmit the data.

For this purpose computing elements, in particular microprocessors, are provided in the communications controller 5 and/or in the bus guardian 6, on which elements a computer program is run, which is programmed to perform the method according to the invention. FIG. 5 shows the communications controller 5 and the bus guardian 6 in schematic form. They have an electrical memory storage element 10, which takes the form, in particular, of a flash memory. The computer program, which is programmed to perform the method according to the invention is stored on the memory storage element 10. The computer program is executed by transferring it, either in sections or in its entirety, to the computing element 11 where it is run. The computer program is transferred from the memory storage element 10 to the computing element 11 via a data transmission connection 12. The data transmission connection 12 takes the form, for example, of a bus system. The results of calculations, which are obtained during the running of the computer program on the computing element 11, can also be transferred in the opposite direction via the data transmission connection 12 to the memory storage element 10 where they are stored.

The present invention can also obviously be implemented in the form of hardware. This has the advantage that the bus guardian 6 does not need a separate computing element 11 (processor), on which the computer program is executed. Instead, the bus guardian 6 can be expanded by means of very few additional hardware components, so that it can perform the method according to the invention.

1. A method of transmitting user data via a communications medium (2) between subscribers (3) connected to the communications medium (2),wherein the data are transmitted in recurrent cycles (8) and in each cycle (8) at least one slot (9, 10) is intended for the user data of at least one subscriber (3),
characterized in that at least one of the slots (10) is used for the transmission of the user data of different subscribers (3) in different cycles (8).

2. A method as claimed in claim 1, characterized in that one of the subscribers (3) decides, on the basis of a condition universally available to all subscribers (3), whether in the current cycle (8) it may transmit user data in at least one shared slot (10) used by multiple subscribers (3).

3. A method as claimed in claim 2, characterized in that a cycle counter, which consecutively numbers successive cycles (8) within a metacycle (11) is used as universally available condition, wherein a metacycle (11) comprises multiple cycles (8).

4. A method as claimed in claim 2, characterized in that_a bus guardian (6) assigned to one of the subscribers (3) determines whether the subscriber (3) may transmit user data in the current slot (9, 10) of the current cycle (8), wherein the bus guardian (6) has at least indirect access to the universally available condition.

5. A method as claimed in claim 3, characterized in that the bus guardian (6) has a counter, which is synchronized with the cycle counter.

6. A method as claimed in claim 5, characterized in that the counter of the bus guardian (6) is synchronized with the cycle counter by means of a synchronization signal.

7. A method as claimed in claim 6, characterized in that a signal already present in the bus guardian (6) is used as synchronization signal.

8. A method as claimed in claim 7, characterized in that the signal already present in the bus guardian (6) assumes a predefinable value at a predefinable synchronization time and the counter of the bus guardian (6) is synchronized to the cycle counter, when the signal assumes the predefinable value.

9. A method as claimed in claim 8, characterized in that the signal already present in the bus guardian (6) assumes the predefinable value for the first time at the predefinable synchronization time.

10. A method as claimed in claim 6, characterized in that a separate signal not originally present in the bus guardian (6) is used as synchronization signal.

11. A method as claimed in claim 10, characterized in that the signal not originally present in the bus guardian (6) is an existing signal present in the bus guardian (6) which has a predefinable value not originally present or a specific signal pattern.

12. A method as claimed in claim 5, characterized in that the counter of the bus guardian (6) is synchronized in that the bus guardian (6) observes the transmission mode of the subscriber (3) assigned to it and synchronizes the counter accordingly.

13. A method as claimed in claim 4, characterized in that information on which slot (9, 10) and which cycle (8) the subscriber (3) assigned to the bus guardian (6) may use to transmit user data is filed in the bus guardian (6) as a preliminary to the data transmission.

14. A method as claimed in claim 4, characterized in that the bus guardian (6) obtains information on which slot (9, 10) and which cycle (8) the subscriber (3) may use to transmit user data by observing the transmission mode of the subscriber (3) assigned to it, and the information is filed in the bus guardian (6).

15. A method as claimed in claim 14, characterized in that the obtaining of information by the bus guardian (6) is undertaken under certain boundary conditions.

16. A computer program which is capable of running on a computing element (11), in particular on a microprocessor, characterized in that the computer program is programmed to perform a method as claimed in claim 1.

17. A computer program as claimed in claim 16, characterized in that the computer program is stored on a memory storage element (10), in particular on a random access memory, on a read-only memory or on a flash memory.

18. A subscriber (3) which can be connected to a communications medium (2) for the transmission of user data via the communications medium (2) to further subscribers (3) that can be connected to the communications medium (2), wherein the data are transmitted in recurrent cycles (8) and at least one slot (9, 10) in each cycle (8) is intended for the user data of at least one subscriber (3), characterized in that at least one of the slots (10) is intended for the transmission of the user data of different subscribers (3) in different cycles (8) and the subscriber (3) in a predefinable cycle (8) transmits user data in the shared slot (10) useable by multiple subscribers (3).

19. A bus guardian (6), which is assigned to a subscriber (3) connectable to a communications medium (2), wherein the subscriber (3) is designed for the transmission of user data via the communications medium (2) to further subscribers (3) connected to the communications medium (2), and wherein the data are transmitted in recurrent cycles (8) and at least one slot (9, 10) in each cycle (8) is intended for the user data of at least one subscriber (3), characterized in that at least one slot (9, 10) is provided, via which user data of different subscribers (3) can be transmitted in different cycles (8), wherein the bus guardian (6) determines whether the subscriber (3) may transmit user data in the current slot (10) of the current cycle (8).

20. A bus guardian (6), which is assigned to a subscriber (3) connectable to a communications medium (2), wherein the subscriber (3) is designed for the transmission of user data via the communications medium (2) to further subscribers (3) connected to the communications medium (2), and wherein the data are transmitted in recurrent cycles (8) and at least one slot (9, 10) in each cycle (8) is intended for the user data of at least one subscriber (3), characterized in that at least one slot (9, 10) is provided, via which user data of different subscribers (3) can be transmitted in different cycles (8), wherein the bus guardian (6) determines whether the subscriber (3) may transmit user data in the current slot (10) of the current cycle (8) characterized in that the bus guardian (6) has means of performing a method as claimed in claim 2.

21. A communications system (1) comprising a communications medium (2) and a plurality of subscribers (3) connected thereto, wherein user data are transmitted between the subscribers (3) via the communications medium (2) in recurrent cycles (8) and at least one slot (9, 10) in each cycle (8) is intended for the user data of at least one subscriber (3), characterized in that at least one of the slots (10) is intended for the transmission of the user data of different subscribers (3) in different cycles (8).

22. A communications system (1) as claimed in claim 21, characterized in that a bus guardian (6), which determines whether the subscriber (3) may transmit user data in the current slot (9, 10) of the current cycle (8) is assigned to at least one of the subscribers (3) of the communications system (1).

23. A communications system (1) comprising a communications medium (2) and a plurality of subscribers (3) connected thereto, wherein user data are transmitted between the subscribers (3) via the communications medium (2) in recurrent cycles (8) and at least one slot (9, 10) in each cycle (8) is intended for the user data of at least one subscriber (3), characterized in that at least one of the slots (10) is intended for the transmission of the user data of different subscribers (3) in different cycles (8), characterized in that a bus guardian (6), which determines whether the subscriber (3) may transmit user data in the current slot (9, 10) of the current cycle (8) is assigned to at least one of the subscribers (3) of the communications system (1), characterized in that the bus guardian (6) has means of performing a method as claimed in claim 2.
